(19) United States
(12) Patent Application Publication
(10) Pub. No.: US 2026/0023846 A1
(43) Pub. Date: Jan. 22, 2026

(54) DATA PATH PROTECTION WITH PARITY INFORMATION

(71) Applicant: Micron Technology, Inc., Boise, ID (US)

(72) Inventors: Casto Salobrena Garcia, München (DE); Marcos Alvarez Gonzalez, München (DE); Michael Dieter Richter, Ottobrunn (DE); Thomas Hein, München (DE); Ronny Schneider, Höhenkirchen-Siegertsbrunn (DE)

(21) Appl. No.: 19/261,508

(22) Filed: Jul. 7, 2025

Related U.S. Application Data
(60) Provisional application No. 63/672,163, filed on Jul. 16, 2024.

(51) Int. Cl. G06F 21/55; G06F 21/62

(52) U.S. Cl. CPC G06F 21/554; G06F 21/6218; G06F 2221/034

(57) ABSTRACT

Methods, systems, and devices for data path protection with parity information are described. A data path protection scheme for a data path within a memory system may include conveying poison information and parity information via the data path. A data encoder of the data path may convert data between first and second modulation schemes using codewords. The data encoder may repurpose a reserved, unused, or unassigned codeword to indicate the poison information. For example, the data encoder may output the reserved codeword to indicate that corresponding data is poisoned. The data encoder may output the reserved codeword in place of a portion of the poisoned data. An encoder previously used to encode the poison information may be used to convey the parity information in the data path, and may output a fourth codeword representative of the parity information to provide data protection for the data path.

### CROSS REFERENCE

The present Application for Patent claims priority to U.S. Patent Application No. 63/672,163 by Garcia et al., entitled “DATA PATH PROTECTION WITH PARITY INFORMATION,” filed Jul. 16, 2024, which is assigned to the assignee hereof, and which is expressly incorporated by reference in its entirety herein.

### TECHNICAL FIELD

The following relates to one or more systems for memory, including data path protection with parity information.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports data path protection with parity information in accordance with examples as disclosed herein.

FIGS. 2 and 3 show examples of data path diagrams that support data path protection with parity information in accordance with examples as disclosed herein.

FIG. 4 shows a block diagram of a memory system that supports data path protection with parity information in accordance with examples as disclosed herein.

FIG. 5 shows a flowchart illustrating a method or methods that support data path protection with parity information in accordance with examples as disclosed herein.

### DETAILED DESCRIPTION

In some memory systems (e.g., dynamic random access memory (DRAM) systems), a host system may communicate data and metadata (e.g., poison information, data severity information) with a memory system via a data path. The data path may include multiple portions, such as a memory array portion, a data path portion, and an interface portion. Operations performed in one or more of the portions (e.g., the memory array and interface portions) may be protected from errors (e.g., bit flips) via one or more error correction schemes (e.g., cyclic redundancy check (CRC), error correction code (ECC)). In some cases, operations within the data path portion (e.g., a portion associated with encoding and decoding data, a portion including one or more encoders or decoders) may be unprotected from errors, in some examples. Circuitry within the data path portion (e.g., one or more encoders) may be associated with encoding or decoding signaling and transferring the signaling from a first modulation scheme to a second modulation scheme, or vice versa. A quantity of bits that the circuitry is capable of processing may be too small to include error detection or error correction bits, in some examples. Such lack of protection may result in errors that occur as data is encoded, decoded, or otherwise transferred through the data path portion. The memory system and host system may be unable to detect such errors. The undetected errors may cause operating failures, reduced reliability, and reduced performance at the memory system.

According to the techniques described herein, the memory system may implement a data path protection scheme for the data path portion that may include conveying both poison information (e.g., or other metadata) and parity information via the data path without allocating extra bit counts to the transfer to provide for end-to-end protection of a data transmission for both read and write operations in memory systems. For example, an encoder of the memory system (e.g., a data encoder within the data path portion) may convert data between the first and second modulation schemes using codewords, where a reserved (e.g., unused, invalid) codeword may be repurposed to indicate the metadata (e.g., the poisoned data indicator), and the memory system may repurpose an encoder previously used to encode poison information (e.g., a metadata encoder) to communicate parity information (e.g., to communicate parity information instead of the poison information).

For example, for a given data transfer (e.g., read or write), one or more data encoders of the data path portion may receive one or more first codewords according to a first modulation scheme, where the one or more first codewords may be representative of information that may include data, poison information, or both. At least one metadata encoder may receive a second codeword according to the first modulation scheme, the second codeword being representative of parity information associated with the information. The one or more data encoders may generate one or more third codewords representative of the information according to a second modulation scheme, and the metadata encoder may generate a fourth codeword representative of the parity information according to the second modulation scheme. If the data in the information is poisoned, the information may include the poison information in addition to or in place of at least a portion of the data. For example, the one or more data encoders may output the reserved codeword to indicate that the data is poisoned. The metadata encoder may output the fourth codeword representative of the parity information, which may provide data protection for the data path portion.

In addition to applicability in memory systems as described herein, techniques for data path protection with parity information may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by protecting data from errors occurring on a data path between a host device and a memory device, which may reduce undetected errors in the memory system and increase overall performance of the memory system, among other benefits.

Additionally, or alternatively, techniques for data path protection with parity information may be generally implemented to improve security and/or reliability features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by protecting data from errors occurring on a data path between a host device and a memory device, which may reduce undetected errors in the memory system, increase reliability and security of data in the memory system, among other benefits.

Features of the disclosure are illustrated and described in the context of systems and architectures. Features of the disclosure are further illustrated and described in the context of data path diagrams and flowcharts. The term “codeword” used herein may refer to one or more symbols, signals, messages, or other digital communication. One or more codewords may represent (e.g., be representative of) a set of information to one or more digital systems (e.g., a memory system, a host system, a memory device). As used herein, a codeword that “includes” or “indicates” information may have a same meaning as the codeword being representative of the information.

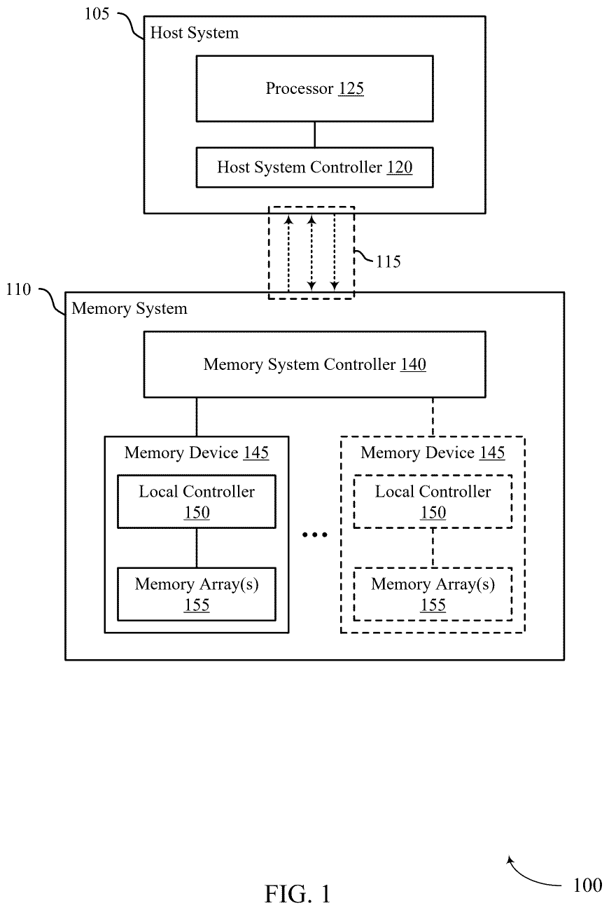

FIG. 1 illustrates an example of a system 100 that supports data path protection with parity information in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0), and may be an example of an M-ary modulation scheme where M is equal to two. Examples of binary-symbol modulation schemes include non-return-to-zero (NRZ), unipolar encoding, bipolar encoding, Manchester encoding, pulse amplitude modulation (PAM) having two symbols (e.g., PAM2), and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where M is greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

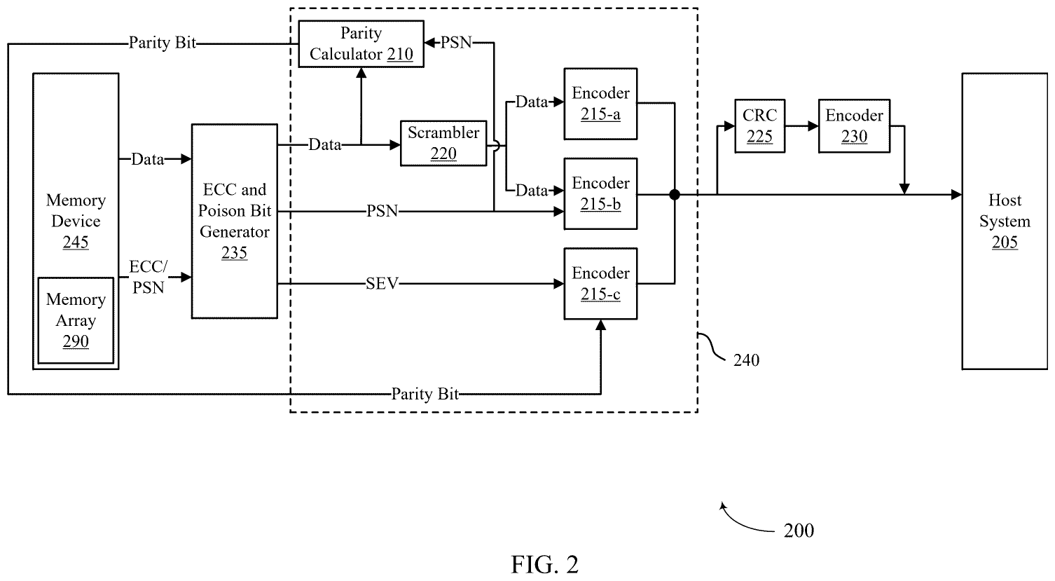

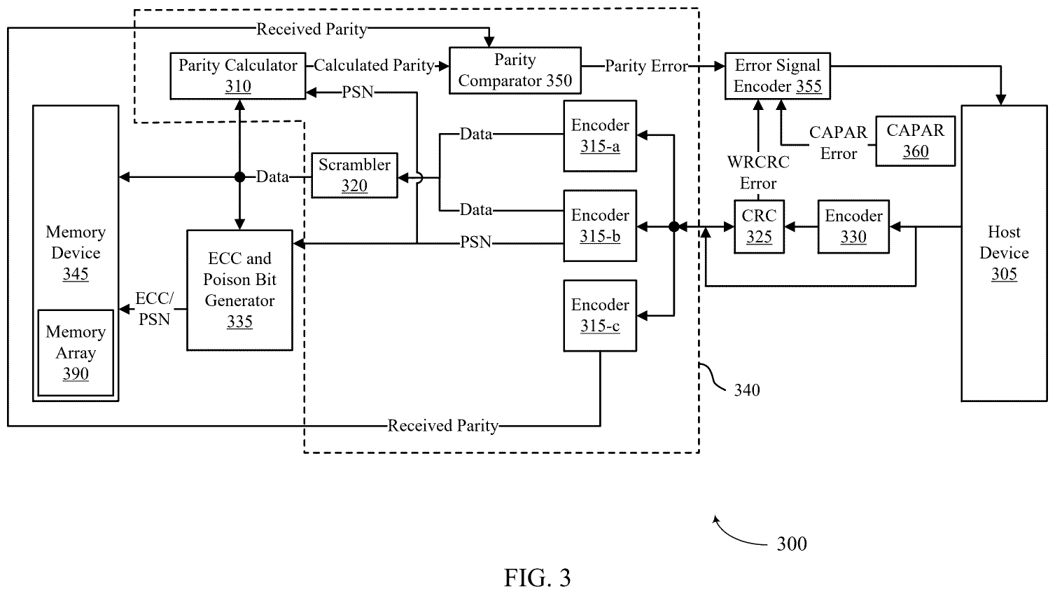

In some cases, a data path associated with the memory system 110 and the host system 105 (e.g., within the channel 115, within the memory system 110, or any combination thereof) may include one or more portions. For example, the data path may include a memory array portion, a data path portion, and an interface portion (e.g., as described herein with respect to FIGS. 2 and 3). In some examples, the memory array portion may be associated with communicating signaling between the data path portion and a memory array 155 of a memory device 145 (e.g., a DRAM core), and the interface portion may be associated with communicating signaling between the data path portion and the host system 105 (e.g., a host device), such that the data path portion may be in between the memory array portion and the interface portion of the data path. In some examples, the channels 115 may represent the interface portion, the data path portion, or both. In some cases, the data path portion may include one or more components (e.g., circuitry), including one or more encoders (e.g., one or more data encoders, one or more metadata encoders, or both), a scrambler, or any combination thereof. The encoders may encode (e.g., or decode) codewords representing information according to a first modulation scheme (e.g., associated with a first quantity of levels per unit of information, bits) into codewords representing the information according to a second modulation scheme (e.g., associated with a second quantity of levels per unit of information, trits, symbols). In some cases, different encoders may be capable of encoding (e.g., or decoding) different quantities of information (e.g., bits, trits, symbols). For example, an encoder may be termed an X bit to Y symbol (XbYS) encoder (e.g., where X and Y are positive integers) if the encoder is capable of encoding X bits into Y symbols (e.g., and vice versa).

In some memory systems, the data path portion may not implement a data

protection scheme. For example, the memory array portion and the interface portion may be protected from data errors via implementing error correction schemes (e.g., ECC and CRC, respectively), but the data path portion may be unprotected from data errors that originate in the data path portion. For example, information passing through the data path portion in a read or write operation may experience an error (e.g., a bit flip, data corruption). Such an error may not be detected by the memory system 110 due to a lack of data protection scheme associated with the data path portion, and may lead to data corruption and poor system performance at the memory system 110, the host system 105, or both. Additionally, the circuitry within the data path portion may not be capable, in some examples, of processing more information (e.g., insufficient bandwidth) to allow for bits associated with an error correction scheme.

In some memory systems, a metadata encoder of the data path portion may be dedicated to processing poison information (e.g., a poisoned data indicator, a poison flag, a poison bit, one or more bits indicative of a poison status). In some cases, the poison information may indicate whether corresponding data (e.g., being processed by one or more data encoders) is poisoned (e.g., corrupted beyond correction). In some cases, a device that receives a poison indication may receive the poisoned data and may discard, disregard, or otherwise ignore the received poisoned data in accordance with the poison indication. For example, the memory system 110 may not store write data if the poisoned data indicator indicates that the write data is poisoned, or the host system 105 may not transmit the poisoned write data, or both. Additionally, or alternatively, the host system 105 may discard read data if the poisoned data indicator indicates that the read data is poisoned, or the memory system 110 may not transmit the poisoned read data, or both.

According to the techniques described herein, the system 100 may implement a data path protection scheme for the data path portion. For example, the data path protection scheme may include conveying both poison information and parity information associated with data (e.g., read data, write data) via the data path (e.g., including the data path portion). In some cases, the parity information may be based on the value of the data prior to entering the data path portion, and may be a data protection mechanism for recognizing one or more errors in the values of the data. For example, if the data is poisoned, a data encoder of the data path portion may be configured to indicate the poisoned data indicator using one or more unused codewords, and the memory system may repurpose a metadata encoder (e.g., an encoder previously used to indicate poison information) to communicate parity information for the data and protect the data through the data path portion. Since the data is discarded if the data is poisoned, at least a portion of the data may not be transferred and the poison indication may be conveyed in place of the portion of the data, without any loss to the system.

For example, for a data transfer (e.g., a read operation, a write operation) between the host system 105 and the memory system 110, one or more data encoders of the data path portion may receive one or more first codewords representative of information according to a first modulation scheme from a first device (e.g., from the memory system 110 for a read operation, from the host system 105 for a write operation), where the information may include data, poison information (e.g., metadata), or both. Additionally, at least one metadata encoder of the data path portion may receive a second codeword representative of parity information for the information according to the first modulation scheme from the first device. The one or more data encoders may generate one or more third codewords representative of the information according to a second modulation scheme, and the metadata encoder may generate a fourth codeword representative of the parity information according to the second modulation scheme. The system 100 may then transfer the one or more third codewords and the fourth codeword to a second device (e.g., to the host system 105 for a read operation, to the memory system 110 for a write operation). If the information (e.g., the data) is poisoned, the one or more first codewords received at the data encoders may indicate the metadata (e.g., poisoned data indicator, poison information, one or more bits indicative of a poison status of the data) in addition to or instead of at least a portion of the data.

In some cases, a value of one of the third codewords (e.g., outputted from the one or more data encoders) may be dedicated to indicating the poison information. For example, a data encoder that receives a portion of the one or more first codewords may be a three bits to two symbol (3b2S) encoder, and may operate according to Table 1 (e.g., a 3b2S truth table).

TABLE 1
3b2S Encoder/Decoder Truth Table

| | | | | Internal Binary Representation | | | | | |
|---|---|---|---|---|---|---|---|---|---|
| | 3 Bits of Data | | | S1 | S1 | S0 | S0 | | |
| 1 Bit | MSB | | LSB | MSB | LSB | MSB | LSB | 2 Trits | |
| PSN | b2 | b1 | b0 | b3 | b2 | b1 | b0 | S1 | S0 |
| 0 | 0 | 0 | 0 | 0 | 1 | 0 | 0 | 0 | −1 |
| 0 | 0 | 0 | 1 | 0 | 0 | 1 | 1 | −1 | 1 |
| 0 | 0 | 1 | 0 | 1 | 1 | 0 | 0 | 1 | −1 |
| 0 | 0 | 1 | 1 | 0 | 1 | 1 | 1 | 0 | 1 |
| 1 | Poison Indicator/Invalid | | | 0 | 1 | 0 | 1 | 0 | 0 |
| 0 | 1 | 0 | 0 | 0 | 0 | 0 | 0 | −1 | −1 |
| 0 | 1 | 0 | 1 | 0 | 0 | 0 | 1 | −1 | 0 |
| 0 | 1 | 1 | 0 | 1 | 1 | 0 | 1 | 1 | 0 |
| 0 | 1 | 1 | 1 | 1 | 1 | 1 | 1 | 1 | 1 |

In Table 1, each row may indicate codewords of different modulation schemes, such as, for example, binary (e.g., each symbol representing two bits of information) and ternary (e.g., using Trits, base 3, pulse amplitude modulation 3 (PAM 3) values), where each symbol represents three bits of information. The codewords may be input to and output from the data encoder (e.g., via data channel DQ0, DQ1, etc.) to encode a signal. For example, the “3 Bits of Data” columns (e.g., most significant bit (MSB) (e.g., bit 2 (b2)), least significant bit (LSB) (e.g., bit 0 (b0)), and bit 1 (b1)) may indicate bit values for a first codeword indicating information according to a first modulation scheme (e.g., binary), and the “2 Trits” columns (e.g., symbol 1 (S1), symbol 2 (S2)) may define symbol values for a second codeword indicating the information according to a second modulation scheme (e.g., ternary, PAM 3). The “Internal Binary Representation” columns (e.g., b3, b2, b1, b0) may indicate bit values used within the data encoder to translate between the two modulation schemes.

In some cases, a first modulation scheme used by the data encoder may be capable of representing more values than the second modulation scheme used by the data encoder (e.g., one more value, or some other quantity of values). In the example of the 3b2S encoder described by Table 1, the “2 Trits” of the ternary modulation scheme may be capable of indicating one more value than the “3 Bits” of the binary modulation scheme. For example, two ternary symbols may represent up to 9 different values (e.g., 3²), and 3 bits may represent up to 8 different values (e.g., 2³). Thus, one value of the “2 trits” (e.g., “00”), and thus one value of the “Internal Binary Representation,” (e.g., “0101”) may be unused (e.g., invalid, an unassigned sequence). According to the techniques described herein, the system 100 may reserve the unused value to indicate poison information (e.g., via the DQ4 channel, in the given example) for read and write operations. For example, each entry in the “1 Bit” column of Table 1 may indicate if the corresponding row is a poison data indication (e.g., indicates that any accompanying data is poisoned). Thus, the value of a row with a “1” in the “1 Bit” column may indicate that the data in the data path of the system 100 is poisoned data. It is noted that the values of Table 1 are merely exemplary, and any of the values of the “2 Trits” may be the unused value (e.g., and thus used for a poisoned data indicator). Additionally, or alternatively, the techniques described herein are not limited to binary and ternary modulation schemes, but may be applicable to any combination of modulation schemes associated with any quantity of codewords, and any one or more unused values (e.g., one or more unassigned sequences, one or more invalid values).

As the data processed in the metadata encoder may be a portion of read or write data transferred in a read or write operation, the read or write data may be incomplete (e.g., invalidated) if the data encoder communicates the poison information instead of the portion of the read or write data. However, the memory system 110, the host system 105, or both, may ignore poisoned data, and thus the incomplete read or write data may not negatively affect the system 100. In some cases, the memory system 110 may implement one or more other data protection schemes (e.g., CRC) on the “Internal Binary Representation” codewords. The 3b2S encoder and Table 1 are merely exemplary, and the techniques described herein may be applied to any encoder, any combination of modulation schemes, and reserved codeword (e.g., an invalid or unused codeword).

FIG. 2 shows an example of a data path diagram 200 that supports data path protection with parity information in accordance with examples as disclosed herein. In some cases, aspects of the data path diagram 200 may implement or be implemented by aspects of FIG. 1. For example, the data path diagram 200 may include a memory device 245 (e.g., a DRAM device), a memory array 290, a host system 105, and a data path portion 240, which may be examples of the memory devices 145 (e.g., or the memory system 110), a memory array 155, the host system 105, and the data path portion, respectively, as described herein with respect to FIG. 1. Additionally, the data path diagram 200 may include one or more encoders 215, where an encoder 215-a and an encoder 215-b may be examples of the data encoders as described with respect to FIG. 1, and the encoder 215-c may be an example of the metadata encoder as described with respect to FIG. 1. In some aspects, the data path diagram 200 may illustrate a data path and corresponding codewords and other signals exchanged therein when performing a read operation (e.g., a read data path) between the memory device 245 and the host system 205 using data path protection with parity information.

The data path portion 240 may include the one or more encoders 215, where the one or more encoders 215 may communicate data, poison information (e.g., also referred to as PSN), severity information (e.g., also referred to as SEV), or any combination thereof, between the memory device 245 and the host system 205. In some cases, the severity information (e.g., one bit) may indicate a severity of errors detected (e.g., by an ECC and poison bit generator 235) in read data from a memory array 290 of the memory device 245. The encoders may encode signals from a first modulation scheme (e.g., binary, NRZ) to a second modulation scheme (e.g., ternary, PAM3), or vice versa. For example, the memory device may communicate via the first modulation scheme and the host system 205 may communicate via the second modulation scheme. Although examples of modulation schemes are given herein, the techniques described herein may apply to any combination of modulation schemes.

In some examples, portions of the data path diagram 200 that are outside of the data path portion 240 may implement one or more other data protection schemes (e.g., ECC, CRC). For example, the CRC module 225 and the encoder 230 may provide protection for information that passes between the data path portion 240 and the host system 205 (e.g., via an interface with the host system 205), and the ECC and poison bit generator 235 provide protection for information (e.g., data, ECC/PSN) that passes between the memory array of the memory device 245 and the data path portion 240.

The data path diagram 200 may illustrate one or more actions performed during a read operation in a memory system. The host system 205 may transmit a read command to the memory device 245, and the read command may indicate data to be read from the memory array 290 (e.g., from one or more memory arrays in the memory device 245). The memory device 245 may retrieve the data and corresponding metadata (e.g., ECC bits, poison information) from the memory array 290, and may transmit the data (e.g., 256 bits or some other quantity) and the corresponding metadata (e.g., a data transfer payload) to the ECC and poison bit generator 235. In some examples, the ECC and poison bit generator 235 may perform an error correction operation (e.g., using the ECC bits), a poison detection operation (e.g., using the poison information, or to determine poison information (1 bit)), a severity detection operation (e.g., based on the error correction operation, to determine severity information), or any combination thereof, on the retrieved data. The ECC and poison bit generator 235 may transmit the data to a parity calculator 210 and a scrambler 220. Additionally, or alternatively, the ECC and poison bit generator 235 may transmit the poison information (e.g., either retrieved from the memory array 290 or generated at the ECC and poison bit generator 235) to the encoder 215-b (e.g., a data encoder, a 3b2S encoder) of the data path portion 240, and may transmit the severity information to the encoder 215-c (e.g., a metadata encoder, a two bit to one symbol (2b1S) encoder, an encoder sometimes used for communicating poison information) of the data path portion 240.

The parity calculator 210 may receive the data from the ECC and poison bit generator 235 (e.g., ECC corrected data) and calculate one or more parity bits for the data. In some cases, the parity calculator 210 may also receive an indication of the poison information and may calculate the one or more parity bits based on the poison information. For example, the parity calculator 210 may calculate one bit of parity information for the data, the poison information, or both (e.g., an even or an odd parity). The parity calculator 210 may send a codeword representative of the one or more parity bits to an encoder 215-c in response to calculating the one or more parity bits. The scrambler 220 may prepare one or more portions of the data to be sent to one or more of the encoders 215. For example, the encoder 215-a (e.g., one or more data encoders, one or more 11 bit to seven symbol (11b7S) encoders) may receive one or more codewords representative of a first portion (e.g., 253 bits or some other data size) of the data from the scrambler 220. The encoder 215-b may receive a second codeword representative of a second portion (e.g., three bits or some other data size) of the data from the scrambler 220 in addition to or instead of receiving the poison information from the ECC and poison bit generator 235. In some cases, the encoders 215 may receive the codewords according to a first modulation scheme associated with the memory device 245 (e.g., binary).

Each encoder 215 may output a respective one or more codewords to the host system 205 and the CRC module 225. The one or more codewords may represent one or more symbols, and the encoders 215 may generate the one or more codewords according to a second modulation scheme associated with the host system 205 (e.g., ternary, PAM3). For example, the encoder 215-a may output one or more codewords (e.g., 161 symbols or some other quantity of symbols) representative of the received first portion of data. The encoder 215-c may output one or more codewords (e.g., one symbol or some other quantity of symbols) representative of the one or more received parity bits, the severity information, or both.

In some cases, the encoder 215-c may prioritize the severity information (e.g., a severity flag) over the one or more parity bits, such that the codewords received at and output from the encoder 215-c may not indicate parity information values (e.g., Parity =1b, 0b) simultaneously with some severity values (e.g., SEV=1b). For example, the encoder 215-c may be a 2b1S encoder, and the inputs and outputs for the encoder 215-c to communicate the parity information, the severity information, or both, may be described in Table 2.

TABLE 2
PAM3 Encoder for Severity and Parity Information

| | | |
|---|---|---|
| 2 Bit Input | Internal Binary Representation | 1 Trit Output |

| SEV | Parity | b1 | b0 | S0 |
|---|---|---|---|---|
| 1 | — | 0 | 0 | −1 |
| 0 | 1 | 0 | 1 | 0 |
| 0 | 0 | 1 | 1 | 1 |

Similar to Table 1, each row of Table 2 may indicate an input codeword, a corresponding internal binary value, and a corresponding output codeword. For example, the “2 Bit Input” columns (e.g., “SEV and “Parity”) may represent possible values (e.g., according to the first modulation scheme) for severity information and parity information received at the encoder 215-c, and the “1 Trit Output” column (e.g., symbol 0 (“S0”)) may indicate what ternary symbol (e.g., according to the second modulation scheme) the encoder 215-c may output to represent the severity and parity information. As the two input bits described in the “2 Bit Input” columns may indicate up to four values, and the “1 Trit Output” may indicate up to three values, the encoder may not communicate parity information if the severity information is of a value of “1.” Thus, the encoder 215-c may not maintain three possible values for the “2 Bit input” codeword. The values and modulation schemes shown in Table 2 are merely exemplary, and the techniques described herein may apply to any values and modulation schemes.

The output of the encoder 215-b may be based on the value of the poison information received from the ECC and poison bit generator 235. For example, if the poison information indicates that the data is poisoned (e.g., corrupted beyond correction), the encoder 215-b may output a codeword (e.g., two symbols or some other quantity) that indicates that the data is poisoned (e.g., instead of a codeword representative of the second portion of the data received from the scrambler 220). For example, the codeword that indicates that the data is poisoned may be the unused (e.g., invalid, reserved) value of Table 1. For the parity information calculated by the parity calculator 210 and eventually by the host system 205 to be correct, the memory system may determine a fixed value (e.g., the unused value) to indicate the poison information, and the encoder 215-b may output the fixed value (e.g., such as “000,” the unused value of Table 1). Alternatively, if the poison information indicates that the data is not poisoned, the encoder 215-b may output a codeword that represents the received second portion of the data.

The CRC module 225 may receive the combined output of the encoders 215 (e.g., 164 symbols or some other quantity of symbols). As the combined output of the encoders 215 may include the data, the parity information, the severity information, the poison information, or any combination thereof, the CRC module 225 may provide CRC protection for the data as well as the parity information, the severity information, the poison information, or any combination thereof. As the output of the CRC module 225 may be in the first modulation scheme, the encoder 230 (e.g., one or more CRC encoders, one or more 3b2S encoders) may encode the CRC information from the CRC module 225 (e.g., 18 bits) into one or more codewords representative of one or more symbols (e.g., 12 symbols).

The host system 205 may receive the combined outputs of the encoders 215 and the encoder 230 (e.g., 176 symbols) and may calculate parity information based on the received combined outputs. The host system 205 may compare the host-calculated parity information with the parity information calculated by the parity calculator 210. Thus, if the data, the poison information, the severity information, or any combination thereof incurred an error within the data path portion 240 (e.g., a bit flip, a bit corruption), the host system 205 may detect the error. Thus, data passing through the data path portion 240 for a read operation may be error protected via parity information based on the encoder 215-b utilizing an unused encoder value to indicate poison information (e.g., instead of data) if the data is poisoned. For example, a memory system may use the encoder 215-c to generate the codeword representative of the parity information based on transferring the poison information (e.g., poison indication) and the data using the one or more encoders 215-a and 215-b.

FIG. 3 shows an example of a data path diagram 300 that supports data path protection with parity information in accordance with examples as disclosed herein. In some cases, aspects of the data path diagram 300 may implement or be implemented by aspects of FIGS. 1 and 2. For example, a memory device 345 (e.g., a memory system, a DRAM memory device), a memory array 390, an ECC and poison bit generator 335, a parity calculator 310, a scrambler 320, encoders 315-a, 315-b, and 315-c, a CRC module 325, an encoder 330, a data path portion 340, and a host system 305 of the data path diagram 300 may be examples of the memory device 245, the memory array 290, the ECC and poison bit generator 235, the parity calculator 210, the scrambler 220, the encoders 215-a, 215-b, and 215-c, the CRC module 225, the encoder 230, the data path portion 240, and the host system 205, respectively, as described herein with respect to FIG. 2 (e.g., components of the data path diagram 300 and the data path diagram 200 with like names may be like components). In some aspects, the data path diagram 300 may illustrate a data path and corresponding codewords and other signals exchanged therein when performing a write operation (e.g., a write data path) between the host system 305 and the memory device 345 using data path protection with parity information.

The data path diagram 300 may be associated with encoding information via the encoders 315. Information that passes through portions of the data path diagram 300 that are outside of the data path portion 340 may be protected by one or more data protection schemes (e.g., similar to the data path diagram 200), where ECC may protect data between the memory device 345 and the data path portion 340 and CRC may protect data between the host system 305 and the data path portion 340.

The data path diagram 300 may illustrate one or more actions performed during a write operation in a memory system. The host system 305 may transmit a write command (not shown) to the memory device 345, and the host system 305 may output one or more codewords (e.g., according to a second modulation scheme, 176 symbols, or some other quantity of symbols) representative of data (e.g., a data transfer payload) and CRC information associated with the data. The data may include poison information (e.g., information that indicates whether the data is poisoned or not) and host-calculated party information for the data and the poison information. The encoder 330 may receive the CRC information (e.g., 12 symbols or some other quantity), and the CRC module 325 may receive the data (e.g., 164 symbols or some other quantity). The encoder 330 may encode the CRC information from the second modulation scheme to a first modulation scheme, and may send the encoded CRC information (e.g., 18 bits or some other quantity) to the CRC module 325 to perform a CRC check on the data using the encoded CRC information. If the CRC module 325 detects an error in the data, the CRC module 325 may transmit a write CRC error signal (e.g., WRCRC error, one bit, using PAM 3 level 0 signaling) to an error signal encoder 355, which may report the error to the host system 305.

Additionally, or alternatively, a command address parity (CAPAR) module 360 may determine whether a command address of the write command contains one or more errors. If the command address contains one or more errors, the CAPAR module 360 may transmit a CAPAR error signal (e.g., one bit) to the error signal encoder 355, which may report the error to the host system 305.

Whether or not the CRC module 325 detects an error in the second portion of the data, the one or more encoders 315 may each receive a respective portion of the data from the host system 305. For example, an encoder 315-a (e.g., one or more data encoders, one or more 11b7S encoders) may receive one or more first codewords of the data (e.g., 161 symbols or some other quantity) which may include data information. An encoder 315-b (e.g., such as the encoder 215-b, a data encoder, a 3b2S encoder) may receive a second codeword (e.g., two symbols or some other quantity) of the data, which may include one or more of data information and poison information. An encoder 315-c (e.g., a metadata encoder, a 2b1S encoder, an encoder sometimes used for communicating poison information) may receive a third codeword (e.g., one bit or some other quantity) of the data, which may indicate parity information associated with the data information.

Each encoder 315 may output one or more codewords according to the first modulation scheme based on the one or more respective codewords received at each encoder 315. For example, the encoder 315-a may output one or more codewords (e.g., 253 bits or some other quantity) representative of the received data information to a scrambler 320. The encoder 315-c may output a codeword (e.g., one bit or some other quantity) representative of the received parity information to a parity comparator 350. The encoder 315-b may output a codeword representative of either poison information (e.g., one bit or some other quantity) or data information (e.g., three bits or some other quantity). If the encoder 315-b receives poison information that indicates that the data is poisoned, the encoder 315-b may output a codeword that indicates the poison information to the ECC and poison bit generator 335 and the parity calculator 310, where the codeword may be the unused (e.g., reserved, invalid, unassigned) value of Table 1 (e.g., as described herein with respect to FIG. 1). For the parity information calculated by the host system 305 and eventually calculated by the parity calculator 310 to be the same, the memory system may determine a fixed value (e.g., the unused value) to indicate the poison information, and the encoder 315-b may output the fixed value (e.g., such as “000,” the unused value of Table 1). Additionally, or alternatively, if the encoder 315-b receives data information (e.g., indicating that the data is not poisoned), the codeword output by the encoder 315-b may indicate the data information to the scrambler 320.

The scrambler 320 may receive and combine the codewords (e.g., the data) from one or both of the encoders 315-a and 315-b. In response to combining the data, the scrambler 320 may output the combined data to the parity calculator 310, the ECC and poison bit generator 335, the memory device 345, or any combination thereof.

The parity calculator 310 may calculate one or more parity bits (e.g., one bit) for the combined data (e.g., received from the scrambler 320), the poison information (e.g., received from the encoder 315-b), or both, such that the combined data, the poison information, or both, may be parity protected. The parity calculator 310 may calculate the one or more parity bits prior to the ECC and poison bit generator 335 generating ECC for the combined data and poison information. The parity comparator 350 may compare the calculated one or more parity bits with the received parity information (e.g., from the host system 305) to determine if the combined data, the poison information, or both, contain one or more errors. If the parity comparator 350 determines an error, the parity comparator 350 may transmit (e.g., synchronously with performing the write operation) a parity error signal (e.g., one bit) to the error signal encoder 355. (e.g., using a WRCRC error level, using PAM 3level 0 signaling similar to the WRCRC error). The error signal encoder 355 may signal the parity error to the host system 305 based on receiving the parity error signal.

The ECC and poison bit generator 335 may receive, as inputs, the combined data from the scrambler 320, the poison information from the encoder 315-b, or both, and may generate ECC for the inputs. The ECC and poison bit generator may also analyze the poison information to determine whether the data is poisoned. The ECC and poison bit generator 335 may transmit the generated ECC, a poison data indicator, or both, to the memory device 345 in response to generating the ECC, determining that the poison status of the data, the parity comparator 350 determining whether the calculated parity information is correct, or any combination thereof. For example, if the ECC and poison bit generator 335 receives poison information from the encoder 315-b, the ECC and poison bit generator 335 may transmit the poison information and the ECC to the memory device 345.

The memory device 345 may receive write data that includes one or more of the combined data from the scrambler 320, the generated ECC from the ECC and poison bit generator 335, the parity information from the parity calculator 310, and the poison information from the ECC and poison bit generator 335. The memory device 345 may store the write data in the memory array 390 based on the poison information and the calculated parity information. For example, the memory device may refrain from storing the write data in the memory array 390 based on the poison information indicating that the data is poisoned, the calculated parity information failing to match the received parity information, or both. Alternatively, the memory device 345 may store the write data in the memory array 390 based on the poison information indicating that the data is not poisoned, the calculated parity information matching the received parity information, or both.

As described herein, the error signal encoder 355 may signal one or more errors (e.g., CAPAR error, WRCRC error, parity error) to the host system 305 (e.g., ERR feedback for data path protection). In some cases, the error signal encoder 355 may signal different errors to the host system 305 via different techniques. For example, the error signal encoder 355 may transmit one or more signals to the host system 305 to indicate the CAPAR error, the WCRC error, the parity error, or any combination thereof. Additionally, or alternatively, the error signal encoder 355 may store (e.g., log) the parity error (e.g., associated with the data path portion 340) in a separate register (e.g., an information read address, an address of the memory array 390), which may allow the host system 305 to distinguish the parity error from the WCRC error and the CAPAR error. In some cases, the register may self-reset (e.g., delete any stored information) after being read by the host system 305.

The memory system may thereby protect data conveyed via the data path portion 340 and the data path portion 240 during write and read operations, respectively, by utilizing the encoder 315-c (e.g., 215-c) to convey parity information and combining poison information with a portion of the data conveyed via another encoder 315-b (e.g., 215-b).

In some cases, for read operations, write operations, or both, a memory system may indicate whether the memory system supports encoding and decoding of the parity information for the data path portion 340 (e.g., data path protection) to the host system 305. For example, the memory system may transmit a value within an information read data signal (e.g., info read address 3 (IRA3)) to the host system 305 via a data pin (e.g., data query channel 7 (DQ7) or some other pin), where the value may indicate whether the memory system supports (e.g., is capable of implementing) data path protection. In some cases, if the memory system supports data path protection, the value may be “0,” and if the memory system does not support data path protection, the value may be “1,” or vice versa. Additionally, or alternatively, the memory system may set a value within a register (e.g., a mode register, mode register 8 (MR8), operand 8 (OP8), or some other register) to indicate whether data path protection is enabled (e.g., activated) at the memory system. For example, the value may be “0” if the data path protection is not enabled (e.g., a default value), and the value may be “1” if data path protection is enabled, or vice versa. In some cases, support for data path protection may be an optional feature, and thus the host system 205 may read the value of the register, receive the value within the information read data signal, or both, to verify whether the memory system supports data path protection and whether data path protection is enabled. Thus, the encoder 315-c (e.g., or the encoder 215-c of FIG. 2) may receive the parity information from either the memory device 245 or the host system 205 if the data path protection is enabled and supported.

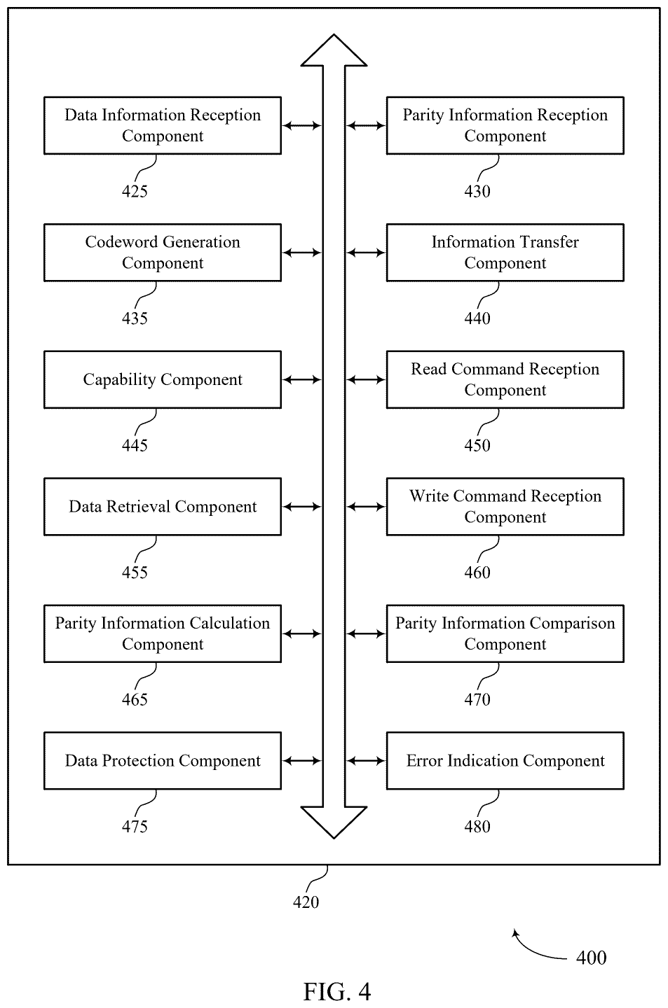

FIG. 4 shows a block diagram 400 of a memory system 420 that supports data path protection with parity information in accordance with examples as disclosed herein. The memory system 420 may be an example of aspects of a memory system as described with reference to FIGS. 1 through 3. The memory system 420, or various components thereof, may be an example of means for performing various aspects of data path protection with parity information as described herein. For example, the memory system 420 may include a data information reception component 425, a parity information reception component 430, a codeword generation component 435, an information transfer component 440, a capability component 445, a read command reception component 450, a data retrieval component 455, a write command reception component 460, a parity information calculation component 465, a parity information comparison component 470, a data protection component 475, an error indication component 480, or any combination thereof. Each of these components, or components of subcomponents thereof (e.g., one or more processors, one or more memories), may communicate, directly or indirectly, with one another (e.g., via one or more buses).

The memory system 420 may support memory operations in accordance with examples as disclosed herein. The data information reception component 425 may be configured as or otherwise support a means for receiving, at one or more first encoders, information associated with data, where the information includes one or more first codewords that are modulated using a first modulation scheme including first symbols that each represent a first quantity of bits of information. The parity information reception component 430 may be configured as or otherwise support a means for receiving, at a second encoder, parity information associated with the data, where the parity information includes a second codeword that is modulated using the first modulation scheme. The codeword generation component 435 may be configured as or otherwise support a means for generating, using the one or more first encoders, one or more third codewords representative of the information based at least in part on receiving the information at the one or more first encoders, where the one or more third codewords are modulated using a second modulation scheme including second symbols that each represent a second quantity of bits of information that is different than the first quantity. In some examples, the codeword generation component 435 may be configured as or otherwise support a means for generating, using the second encoder based at least in part on receiving the parity information at the second encoder, a fourth codeword representative of the parity information, where the fourth codeword is modulated using the second modulation scheme. The information transfer component 440 may be configured as or otherwise support a means for transferring the information and the parity information using the one or more third codewords and the fourth codeword.

In some examples, the capability component 445 may be configured as or otherwise support a means for transmitting, via a data pin of the memory system and based at least in part on an information read address associated with the memory system, an indication that the memory system supports encoding and decoding of the parity information, where receiving the parity information at the second encoder is based at least in part on the indication.

In some examples, the capability component 445 may be configured as or otherwise support a means for storing, in a mode register of the memory system, an indication that support for encoding and decoding of the parity information by the memory system is enabled, where receiving the parity information at the second encoder is based at least in part on the indication.

In some examples, to support generating the one or more third codewords representative of the information, the codeword generation component 435 may be configured as or otherwise support a means for generating, using a first encoder of the one or more first encoders and based at least in part on the information, a third codeword, where a value of the third codeword indicates that the data includes poisoned data based at least in part on metadata, and where the information received at the one or more first encoders includes at least a first codeword that is representative of the metadata and that indicates the data includes the poisoned data.

In some examples, the read command reception component 450 may be configured as or otherwise support a means for receiving a read command to read the data from a memory array of the memory system. In some examples, the data retrieval component 455 may be configured as or otherwise support a means for retrieving the data from the memory array based at least in part on the read command, where receiving the information at the one or more first encoders includes inputting the information including the data, metadata associated with the data, or both to the one or more first encoders based at least in part on retrieving the data, and where transferring the information and the parity information using the one or more third codewords and the fourth codeword includes transferring the information and the parity information via an interface between the memory system and a host system based at least in part on the read command.

In some examples, the parity information calculation component 465 may be configured as or otherwise support a means for calculating the parity information associated with the data based at least in part on retrieving the data from the memory array, where receiving the parity information at the second encoder includes inputting the parity information to the second encoder based at least in part on calculating the parity information.

In some examples, the data protection component 475 may be configured as or otherwise support a means for performing an error correction and poison detection operation associated with the data based at least in part on retrieving the data from the memory array, where receiving the information at the second encoder includes inputting the data, metadata associated with the data, or both to the one or more first encoders based at least in part on the error correction and poison detection operation.

In some examples, the write command reception component 460 may be configured as or otherwise support a means for receiving a write command to write the data to a memory array of the memory system, where receiving the information at the one or more first encoders includes receiving the information at the one or more first encoders via an interface between the memory system and a host system based at least in part on the write command, and where transferring the information and the parity information using the one or more third codewords and the fourth codeword includes writing the information and the parity information to the memory array based at least in part on the write command.

In some examples, the write command reception component 460 may be configured as or otherwise support a means for receiving a write command to write the information to a memory array of the memory system. In some examples, the parity information calculation component 465 may be configured as or otherwise support a means for calculating second parity information associated with the information based at least in part on the write command and generating the one or more third codewords. In some examples, the parity information comparison component 470 may be configured as or otherwise support a means for comparing the second parity information with the fourth codeword representative of the parity information based at least in part on generating the fourth codeword. In some examples, the data protection component 475 may be configured as or otherwise support a means for determining whether the information includes an error based at least in part on the comparing.

In some examples, to support transferring the information and the parity information using the one or more third codewords and the fourth codeword, the information transfer component 440 may be configured as or otherwise support a means for writing the information and the parity information to the memory array using the one or more third codewords and the fourth codeword based at least in part on the write command and determining that the information does not include the error.

In some examples, the error indication component 480 may be configured as or otherwise support a means for transmitting an indication of the error associated with the information based at least in part on determining that the information includes the error.

In some examples, the error indication component 480 may be configured as or otherwise support a means for writing, to an address of the memory array of the memory system, second information that indicates the error is associated with a data path in the memory system including the one or more first encoders and the second encoder.

In some examples, to support generating the one or more third codewords representative of the information, the codeword generation component 435 may be configured as or otherwise support a means for generating, using a first encoder of the one or more first encoders and based at least in part on the information, a third codeword, where a value of the third codeword indicates that the data does not include poisoned data, where transferring the information and the parity information using the one or more third codewords and the fourth codeword includes writing the data and the parity information to a memory array of the memory system using the one or more third codewords and the fourth codeword based at least in part on the value indicating that the data does not include the poisoned data.

In some examples, to support transferring the information and the parity information, the information transfer component 440 may be configured as or otherwise support a means for transferring, via the information, either a portion of the data and a poison indication associated with the data or all of the data without the poison indication based at least in part on a poison status of the data, where the poison indication is conveyed via one or more unassigned sequences associated with the one or more first encoders. In some examples, to support transferring the information and the parity information, the information transfer component 440 may be configured as or otherwise support a means for transferring the parity information for protection of a data transfer payload within the information, where using the second encoder to generate the fourth codeword representative of the parity information is based at least in part on transferring the poison indication and the data using the one or more first encoders.

In some examples, the first symbols associated with the first modulation scheme each represent two bits of information and the second symbols associated with the second modulation scheme each represent three bits of information, or vice versa.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

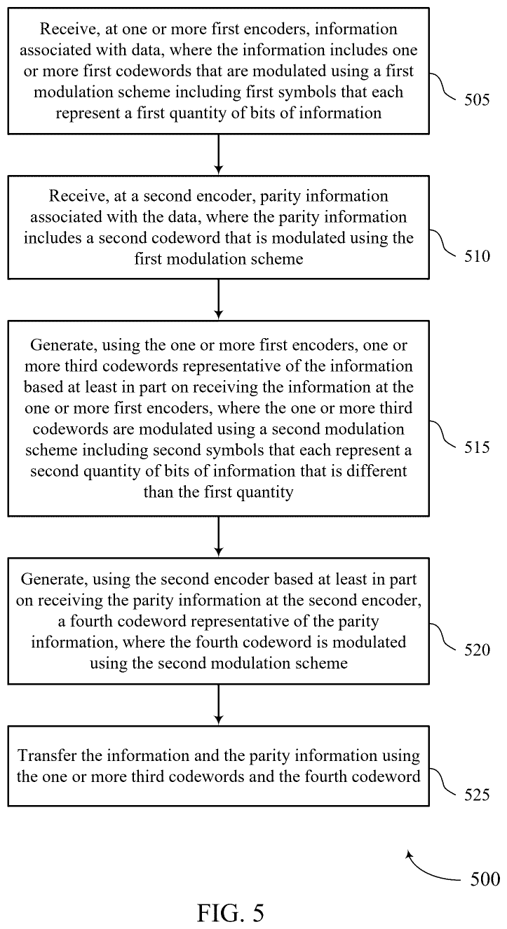

FIG. 5 shows a flowchart illustrating a method 500 that supports data path protection with parity information in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, at one or more first encoders, information associated with data, where the information includes one or more first codewords that are modulated using a first modulation scheme including first symbols that each represent a first quantity of bits of information. In some examples, aspects of the operations of 505 may be performed by a data information reception component 425 as described with reference to FIG. 4.

At 510, the method may include receiving, at a second encoder, parity information associated with the data, where the parity information includes a second codeword that is modulated using the first modulation scheme. In some examples, aspects of the operations of 510 may be performed by a parity information reception component 430 as described with reference to FIG. 4.

At 515, the method may include generating, using the one or more first encoders, one or more third codewords representative of the information based at least in part on receiving the information at the one or more first encoders, where the one or more third codewords are modulated using a second modulation scheme including second symbols that each represent a second quantity of bits of information that is different than the first quantity. In some examples, aspects of the operations of 515 may be performed by a codeword generation component 435 as described with reference to FIG. 4.

At 520, the method may include generating, using the second encoder based at least in part on receiving the parity information at the second encoder, a fourth codeword representative of the parity information, where the fourth codeword is modulated using the second modulation scheme. In some examples, aspects of the operations of 520 may be performed by a codeword generation component 435 as described with reference to FIG. 4.

At 525, the method may include transferring the information and the parity information using the one or more third codewords and the fourth codeword. In some examples, aspects of the operations of 525 may be performed by an information transfer component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at one or more first encoders, information associated with data, where the information includes one or more first codewords that are modulated using a first modulation scheme including first symbols that each represent a first quantity of bits of information; receiving, at a second encoder, parity information associated with the data, where the parity information includes a second codeword that is modulated using the first modulation scheme; generating, using the one or more first encoders, one or more third codewords representative of the information based at least in part on receiving the information at the one or more first encoders, where the one or more third codewords are modulated using a second modulation scheme including second symbols that each represent a second quantity of bits of information that is different than the first quantity; generating, using the second encoder based at least in part on receiving the parity information at the second encoder, a fourth codeword representative of the parity information, where the fourth codeword is modulated using the second modulation scheme; and transferring the information and the parity information using the one or more third codewords and the fourth codeword.

Aspect 2: The method, apparatus, or non-transitory computer-readable medium of aspect 1, further including operations, features, circuitry, logic, means, or instructions, or any combination thereof for transmitting, via a data pin of the memory system and based at least in part on an information read address associated with the memory system, an indication that the memory system supports encoding and decoding of the parity information, where receiving the parity information at the second encoder is based at least in part on the indication.

Aspect 3: The method, apparatus, or non-transitory computer-readable medium of any of aspects 1 through 2, further including operations, features, circuitry, logic, means, or instructions, or any combination thereof for storing, in a mode register of the memory system, an indication that support for encoding and decoding of the parity information by the memory system is enabled, where receiving the parity information at the second encoder is based at least in part on the indication.

Aspect 4: The method, apparatus, or non-transitory computer-readable medium of any of aspects 1 through 3, where generating the one or more third codewords representative of the information includes operations, features, circuitry, logic, means, or instructions, or any combination thereof for generating, using a first encoder of the one or more first encoders and based at least in part on the information, a third codeword, where a value of the third codeword indicates that the data includes poisoned data based at least in part on metadata, and where the information received at the one or more first encoders includes at least a first codeword that is representative of the metadata and that indicates the data includes the poisoned data.

Aspect 5: The method, apparatus, or non-transitory computer-readable medium of any of aspects 1 through 4, further including operations, features, circuitry, logic, means, or instructions, or any combination thereof for receiving a read command to read the data from a memory array of the memory system and retrieving the data from the memory array based at least in part on the read command, where receiving the information at the one or more first encoders includes inputting the information including the data, metadata associated with the data, or both to the one or more first encoders based at least in part on retrieving the data, and where transferring the information and the parity information using the one or more third codewords and the fourth codeword includes transferring the information and the parity information via an interface between the memory system and a host system based at least in part on the read command.

Aspect 6: The method, apparatus, or non-transitory computer-readable medium of aspect 5, further including operations, features, circuitry, logic, means, or instructions, or any combination thereof for calculating the parity information associated with the data based at least in part on retrieving the data from the memory array, where receiving the parity information at the second encoder includes inputting the parity information to the second encoder based at least in part on calculating the parity information.

Aspect 7: The method, apparatus, or non-transitory computer-readable medium of any of aspects 5 through 6, further including operations, features, circuitry, logic, means, or instructions, or any combination thereof for performing an error correction and poison detection operation associated with the data based at least in part on retrieving the data from the memory array, where receiving the information at the second encoder includes inputting the data, metadata associated with the data, or both to the one or more first encoders based at least in part on the error correction and poison detection operation.

Aspect 8: The method, apparatus, or non-transitory computer-readable medium of any of aspects 1 through 7, further including operations, features, circuitry, logic, means, or instructions, or any combination thereof for receiving a write command to write the data to a memory array of the memory system, where receiving the information at the one or more first encoders includes receiving the information at the one or more first encoders via an interface between the memory system and a host system based at least in part on the write command, and where transferring the information and the parity information using the one or more third codewords and the fourth codeword includes writing the information and the parity information to the memory array based at least in part on the write command.

Aspect 9: The method, apparatus, or non-transitory computer-readable medium of any of aspects 1 through 8, further including operations, features, circuitry, logic, means, or instructions, or any combination thereof for receiving a write command to write the information to a memory array of the memory system; calculating second parity information associated with the information based at least in part on the write command and generating the one or more third codewords; comparing the second parity information with the fourth codeword representative of the parity information based at least in part on generating the fourth codeword; and determining whether the information includes an error based at least in part on the comparing.

Aspect 10: The method, apparatus, or non-transitory computer-readable medium of aspect 9, where transferring the information and the parity information using the one or more third codewords and the fourth codeword includes operations, features, circuitry, logic, means, or instructions, or any combination thereof for writing the information and the parity information to the memory array using the one or more third codewords and the fourth codeword based at least in part on the write command and determining that the information does not include the error.

Aspect 11: The method, apparatus, or non-transitory computer-readable medium of aspects 9, further including operations, features, circuitry, logic, means, or instructions, or any combination thereof for transmitting an indication of the error associated with the information based at least in part on determining that the information includes the error.

Aspect 12: The method, apparatus, or non-transitory computer-readable medium of aspect 11, further including operations, features, circuitry, logic, means, or instructions, or any combination thereof for writing, to an address of the memory array of the memory system, second information that indicates the error is associated with a data path in the memory system including the one or more first encoders and the second encoder.

Aspect 13: The method, apparatus, or non-transitory computer-readable medium of any of aspects 1 through 3 and 5 through 12, where generating the one or more third codewords representative of the information includes operations, features, circuitry, logic, means, or instructions, or any combination thereof for generating, using a first encoder of the one or more first encoders and based at least in part on the information, a third codeword, where a value of the third codeword indicates that the data does not include poisoned data, where transferring the information and the parity information using the one or more third codewords and the fourth codeword includes writing the data and the parity information to a memory array of the memory system using the one or more third codewords and the fourth codeword based at least in part on the value indicating that the data does not include the poisoned data.

Aspect 14: The method, apparatus, or non-transitory computer-readable medium of any of aspects 1 through 13, where transferring the information and the parity information includes operations, features, circuitry, logic, means, or instructions, or any combination thereof for transferring, via the information, either a portion of the data and a poison indication associated with the data or all of the data without the poison indication based at least in part on a poison status of the data, where the poison indication is conveyed via one or more unassigned sequences associated with the one or more first encoders and transferring the parity information for protection of a data transfer payload within the information, where using the second encoder to generate the fourth codeword representative of the parity information is based at least in part on transferring the poison indication and the data using the one or more first encoders.

Aspect 15: The method, apparatus, or non-transitory computer-readable medium of any of aspects 1 through 14, where the first symbols associated with the first modulation scheme each represent two bits of information and the second symbols associated with the second modulation scheme each represent three bits of information, or vice versa.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “isolated” may refer to a relationship between components in which signals are not presently capable of flowing between the components. Components are isolated from each other if there is an open circuit between them. For example, two components separated by a switch that is positioned between the components are isolated from each other when the switch is open. When a component isolates two components, the component may initiate a change that prevents signals from flowing between the other components using a conductive path that previously permitted signals to flow.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system for memory operations, comprising:
one or more memories storing processor-executable code; and
one or more processors coupled with the one or more memories and individually or collectively operable to execute the code to cause the memory system to:
receive, at one or more first encoders, information associated with data, wherein the information comprises one or more first codewords that are modulated using a first modulation scheme comprising first symbols that each represent a first quantity of bits of information;
receive, at a second encoder, parity information associated with the data, wherein the parity information comprises a second codeword that is modulated using the first modulation scheme;
generate, using the one or more first encoders, one or more third codewords representative of the information based at least in part on receiving the information at the one or more first encoders, wherein the one or more third codewords are modulated using a second modulation scheme comprising second symbols that each represent a second quantity of bits of information that is different than the first quantity;
generate, using the second encoder based at least in part on receiving the parity information at the second encoder, a fourth codeword representative of the parity information, wherein the fourth codeword is modulated using the second modulation scheme; and
transfer the information and the parity information using the one or more third codewords and the fourth codeword.

2. The memory system of claim 1, wherein the one or more processors are individually or collectively further operable to execute the code to cause the memory system to:
transmit, via a data pin of the memory system and based at least in part on an information read address associated with the memory system, an indication that the memory system supports encoding and decoding of the parity information, wherein receiving the parity information at the second encoder is based at least in part on the indication.

3. The memory system of claim 1, wherein the one or more processors are individually or collectively further operable to execute the code to cause the memory system to:
store, in a mode register of the memory system, an indication that support for encoding and decoding of the parity information by the memory system is enabled, wherein receiving the parity information at the second encoder is based at least in part on the indication.

4. The memory system of claim 1, wherein, to generate the one or more third codewords representative of the information, the one or more processors are individually or collectively operable to execute the code to cause the memory system to:
generate, using a first encoder of the one or more first encoders and based at least in part on the information, a third codeword, wherein a value of the third codeword indicates that the data comprises poisoned data based at least in part on metadata, and wherein the information received at the one or more first encoders comprises at least a first codeword that is representative of the metadata and that indicates the data comprises the poisoned data.

5. The memory system of claim 1, wherein the one or more processors are individually or collectively further operable to execute the code to cause the memory system to:
receive a read command to read the data from a memory array of the memory system; and
retrieve the data from the memory array based at least in part on the read command, wherein receiving the information at the one or more first encoders comprises inputting the information comprising the data, metadata associated with the data, or both to the one or more first encoders based at least in part on retrieving the data, and wherein transferring the information and the parity information using the one or more third codewords and the fourth codeword comprises transferring the information and the parity information via an interface between the memory system and a host system based at least in part on the read command.

6. The memory system of claim 5, wherein the one or more processors are individually or collectively further operable to execute the code to cause the memory system to:
calculate the parity information associated with the data based at least in part on retrieving the data from the memory array, wherein receiving the parity information at the second encoder comprises inputting the parity information to the second encoder based at least in part on calculating the parity information.

7. The memory system of claim 5, wherein the one or more processors are individually or collectively further operable to execute the code to cause the memory system to:
perform an error correction and poison detection operation associated with the data based at least in part on retrieving the data from the memory array, wherein receiving the information at the second encoder comprises inputting the data, the metadata associated with the data, or both to the one or more first encoders based at least in part on the error correction and poison detection operation.

8. The memory system of claim 1, wherein the one or more processors are individually or collectively further operable to execute the code to cause the memory system to:
receive a write command to write the data to a memory array of the memory system, wherein receiving the information at the one or more first encoders comprises receiving the information at the one or more first encoders via an interface between the memory system and a host system based at least in part on the write command, and wherein transferring the information and the parity information using the one or more third codewords and the fourth codeword comprises writing the information and the parity information to the memory array based at least in part on the write command.

9. The memory system of claim 1, wherein the one or more processors are individually or collectively further operable to execute the code to cause the memory system to:
receive a write command to write the information to a memory array of the memory system;
calculate second parity information associated with the information based at least in part on the write command and generating the one or more third codewords;
compare the second parity information with the fourth codeword representative of the parity information based at least in part on generating the fourth codeword; and
determine whether the information comprises an error based at least in part on the comparing.

10. The memory system of claim 9, wherein, to transfer the information and the parity information using the one or more third codewords and the fourth codeword, the one or more processors are individually or collectively operable to execute the code to cause the memory system to:
write the information and the parity information to the memory array using the one or more third codewords and the fourth codeword based at least in part on the write command and determining that the information does not comprise the error.

11. The memory system of claim 9, wherein the one or more processors are individually or collectively further operable to execute the code to cause the memory system to:
transmit an indication of the error associated with the information based at least in part on determining that the information comprises the error.

12. The memory system of claim 11, wherein the one or more processors are individually or collectively further operable to execute the code to cause the memory system to:
write, to an address of the memory array of the memory system, second information that indicates the error is associated with a data path in the memory system comprising the one or more first encoders and the second encoder.

13. The memory system of claim 1, wherein, to generate the one or more third codewords representative of the information, the one or more processors are individually or collectively operable to execute the code to cause the memory system to:
generate, using a first encoder of the one or more first encoders and based at least in part on the information, a third codeword, wherein a value of the third codeword indicates that the data does not comprise poisoned data, wherein transferring the information and the parity information using the one or more third codewords and the fourth codeword comprises writing the data and the parity information to a memory array of the memory system using the one or more third codewords and the fourth codeword based at least in part on the value indicating that the data does not comprise the poisoned data.

14. The memory system of claim 1, wherein, to transfer the information and the parity information, the one or more processors are individually or collectively operable to execute the code to cause the memory system to:
transfer, via the information, either a portion of the data and a poison indication associated with the data or all of the data without the poison indication based at least in part on a poison status of the data, wherein the poison indication is conveyed via one or more unassigned sequences associated with the one or more first encoders; and
transfer the parity information for protection of a data transfer payload within the information, wherein using the second encoder to generate the fourth codeword representative of the parity information is based at least in part on transferring the poison indication and the data using the one or more first encoders.

15. The memory system of claim 1, wherein the first symbols associated with the first modulation scheme each represent two bits of information and the second symbols associated with the second modulation scheme each represent three bits of information, or vice versa.

16. A method for memory operations at a memory system, comprising:
receiving, at one or more first encoders, information associated with data, wherein the information comprises one or more first codewords that are modulated using a first modulation scheme comprising first symbols that each represent a first quantity of bits of information;
receiving, at a second encoder, parity information associated with the data, wherein the parity information comprises a second codeword that is modulated using the first modulation scheme;
generating, using the one or more first encoders, one or more third codewords representative of the information based at least in part on receiving the information at the one or more first encoders, wherein the one or more third codewords are modulated using a second modulation scheme comprising second symbols that each represent a second quantity of bits of information that is different than the first quantity;
generating, using the second encoder based at least in part on receiving the parity information at the second encoder, a fourth codeword representative of the parity information, wherein the fourth codeword is modulated using the second modulation scheme; and
transferring the information and the parity information using the one or more third codewords and the fourth codeword.

17. The method of claim 16, further comprising:
transmitting, via a data pin of the memory system and based at least in part on an information read address associated with the memory system, an indication that the memory system supports encoding and decoding of the parity information, wherein receiving the parity information at the second encoder is based at least in part on the indication.

18. The method of claim 16, further comprising:
storing, in a mode register of the memory system, an indication that support for encoding and decoding of the parity information by the memory system is enabled, wherein receiving the parity information at the second encoder is based at least in part on the indication.

19. The method of claim 16, wherein generating the one or more third codewords representative of the information comprises:
generating, using a first encoder of the one or more first encoders and based at least in part on the information, a third codeword, wherein a value of the third codeword indicates that the data comprises poisoned data based at least in part on metadata, and wherein the information received at the one or more first encoders comprises at least a first codeword that is representative of the metadata and that indicates the data comprises the poisoned data.

20. The method of claim 16, further comprising:
receiving a read command to read the data from a memory array of the memory system; and
retrieving the data from the memory array based at least in part on the read command, wherein receiving the information at the one or more first encoders comprises inputting the information comprising the data, metadata associated with the data, or both to the one or more first encoders based at least in part on retrieving the data, and wherein transferring the information and the parity information using the one or more third codewords and the fourth codeword comprises transferring the information and the parity information via an interface between the memory system and a host system based at least in part on the read command.

21. The method of claim 20, further comprising:
calculating the parity information associated with the data based at least in part on retrieving the data from the memory array, wherein receiving the parity information at the second encoder comprises inputting the parity information to the second encoder based at least in part on calculating the parity information.

22. The method of claim 20, further comprising:
performing an error correction and poison detection operation associated with the data based at least in part on retrieving the data from the memory array, wherein receiving the information at the second encoder comprises inputting the data, the metadata associated with the data, or both to the one or more first encoders based at least in part on the error correction and poison detection operation.

23. A non-transitory computer-readable medium storing code for memory operations, the code comprising instructions executable by one or more processors to:
receive, at one or more first encoders, information associated with data, wherein the information comprises one or more first codewords that are modulated using a first modulation scheme comprising first symbols that each represent a first quantity of bits of information;
receive, at a second encoder, parity information associated with the data, wherein the parity information comprises a second codeword that is modulated using the first modulation scheme;
generate, using the one or more first encoders, one or more third codewords representative of the information based at least in part on receiving the information at the one or more first encoders, wherein the one or more third codewords are modulated using a second modulation scheme comprising second symbols that each represent a second quantity of bits of information that is different than the first quantity;
generate, using the second encoder based at least in part on receiving the parity information at the second encoder, a fourth codeword representative of the parity information, wherein the fourth codeword is modulated using the second modulation scheme; and
transfer the information and the parity information using the one or more third codewords and the fourth codeword.
